(19) United States
(12) Patent Application Publication
(10) Pub. No.: US 2010/0081745 A1
(43) Pub. Date: Apr. 1, 2010

(54) METHOD FOR PREPARING PAINTS AND INKS

(75) Inventor: GIOVANNI BROGGI, MILANO (IT)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: INXEL TRADEMARK & PATENTS SAGL, LUGANO (CH)

(21) Appl. No.: 12/568,798

(22) Filed: Sep. 29, 2009

Related U.S. Application Data
(63) Continuation-in-part of application No. PCT/EP2007/053176, filed on Apr. 2, 2007.

(51) Int. Cl. C08K 5/29; C08K 5/17; C08K 5/10

(52) U.S. Cl. 524/237; 524/186; 524/317

(57) ABSTRACT

The present invention relates to a method for preparing paints and/or inks in which a particle composition consisting of pigment dyestuff, an aldehyde, ketone and/or acrylic resin and optionally excipients and/or adjuvants are mixed into at least one organic solvent, water or a mixture thereof.

The invention also relates to paints and/or inks obtainable using said preparation method and to manufactured items painted and/or treated with such paints and/or inks.

### CROSS REFERENCE TO RELATED APPLICATIONS

This is a continuation-in-part of and claims priority to International Application No. PCT/EP2007/053176, filed Apr. 2, 2007, the teachings of which are incorporated herein by reference.

### SUMMARY

The present invention relates to a method for preparing paints and/or inks in which a particle composition consisting of pigment dyestuff, an aldehyde, ketone and/or acrylic resin and optionally excipients and/or adjuvants is mixed into at least one organic solvent, water or a mixture thereof.

The invention also relates to paints and/or inks obtainable using said preparation method and to manufactured items painted and/or treated with such paints and/or inks.

### BACKGROUND

Liquid paints normally consist of generally organic solvents; resins; pigments and additives. Their preparation normally involves preliminary preparation of a pigment paste (mill-base) or a mixture consisting of an aliquot of solvent, an aliquot of resin, the pigment dyestuff and the additives.

There is then a phase of grinding in a ball mill: the balls may vary in chemical nature and size according to the nature of the pigment which must be ground. Grinding is normally achieved by a dual action of the balls on the pigment particles: an impact action and a friction action.

The process is then concluded by mixing in the missing aliquots of solvent and resin until a liquid paint is obtained.

This method has two distinct problems.

Firstly it obliges the paint manufacturer to be equipped with suitable mills for grinding the pigment in the pigment paste.

Secondly the pigments being ground, in the form of very fine, intangible powder, form clouds of particles which float in the air in the department where the processing is taking place. This extremely light pigment powder contaminates the whole work environment, including the workers involved in the operations but especially the equipment used in the processing.

This restriction is well-known in the industry and makes it necessary to decontaminate the entire work environment very carefully as it would otherwise remain highly contaminated.

The difficulties which may be encountered in preparing these pigment pastes in the solvent phase are therefore clear.

### DESCRIPTION OF THE INVENTION

The invention accordingly relates to a method for preparing liquid paints and/or inks in which a particle composition consisting of one or more pigments coated with at least an aldehyde, ketone and/or acrylic resin and, optionally, at least a mineral reinforcing filler and/or a dispersant is mixed directly into at least one organic solvent, water and/or a mixture thereof to obtain the final paint and/or ink, eliminating the intermediate phase of grinding by the paint manufacturer.

In particular, the preparation method according to the present invention comprises the following phases:
a) pre-mixing:
   i) a particle composition consisting of one or more pigments coated with at least an aldehyde, ketone and/or acrylic resin and, optionally, at least a mineral reinforcing filler and/or a dispersant,
   ii) an alkyd, acrylic, polyester, cellulose, vinyl, urea, melamine, epoxy, epoxy polyamine, silicone, chlorinated rubber resin and/or a mixture thereof,
   iii) at least one organic solvent, water or a mixture thereof,
with consequent obtaining of a pigment paste; and
b) mixing the pigment paste thus obtained with:
   iv) a resin, preferably alkyd, acrylic, polyester, cellulose, vinyl, urea, melamine, epoxy, epoxy polyamine, urethane, silicone, hydrocarbon resins, colophony resin and/or its esters, chlorinated rubber and/or a mixture thereof,
   v) one or more additives, reinforcing fillers and/or dispersants,
   vi) at least one organic solvent, water or a mixture thereof,
      with consequent obtaining of the liquid paint and/or ink.

The particle compositions which may be used for the purposes of the invention are preferably those described in international patent applications PCT/IT2005/000433 (published as WO2006082603), PCT/IT2006/000019 and PCT/IT2006/00588, incorporated herein for reference.

The aldehyde and/or ketone resins contained in said particle composition have, as described in the international patent applications quoted, PCT/IT2005/000433 and PCT/IT2006/000019, an average molecular weight between 800 and 2000 Da, preferably between 900 and 1400 Da, while the acrylic resins have an average molecular weight between 800 and 5000 Da, preferably between 800 and 3000 Da.

Said aldehyde, ketone and/or acrylic resins also have a melting point between 70° and 130° C., preferably between 90° and 110° C.

“Aldehyde and/or ketone resin” means an aldehyde condensation product, preferably aliphatic, or a ketone, preferably cyclohexanone or methylcyclehexanone, optionally with condensation products such as urea/formaldehyde.

Examples of aldehyde and/or ketone resins which may be used according to the invention are Laropal® A 101, Laropal® A 81 and UA resin, which are urea and aliphatic aldehyde condensation products, and Laropal® K 80 which is the product of condensation of cyclohexanone or UK100.

Examples of acrylic resins which may be used in the invention are Joncryl® 67 and 690, Joncryl® 586, 611 and 678, Neocryl B817, B 731, styrene maleic anhydride copolymers such as SMA® 1000, 2000 and 3000 and their esters SMA® 1440, 17352, 2625 and 3840.

As described in patent application PCT/IT2005/000433, incorporated herein by reference, “pigment dyestuff” means an organic or inorganic powder which absorbs part or all of the light spectrum and reflects the complementary part of it constituting visible colour.

The pigments in the invention may be organic or inorganic pigments. The organic pigments are preferably selected from pigments from organic combustion (carbon black), yellow pigments of monoazoic group, quinophthalone, isoindolinone; orange pigments disazopyrazolone, benzimidazolone, diketopyrrolopyrrole; quinacridone red pigments, diketopyrrolopyrrole, of the group AS naphthol, anthraquinone, betaoxy-naphthoic acid spiked with calcium (BONS Ca), betaoxy-naphthoic acid spiked with manganese (BONS Mn); dioxazine violet; blue pigments based on phthalocyanine, green pigments based on phthalocyanine. The inorganic pigments are preferably selected from pigments based on iron oxide, titanium oxide, chromium oxide, yellow pigments nickel-antimony titanate coprecipitates, chromium-antimony titanate coprecipitates; zinc titanate; lead chromate sulphate nickel titanates; bismuth vanadate; orange pigments from chromium sulphate and lead molybdate. In particular, carbon black can be selected from furnace black, gas black, channel black, lamp black, thermal black, acetylene black, plasma black, inversion blacks, (known from DE 195 21 565 and DE 19839925), Si-containing carbon blacks (known from WO 98/45361 or DE 19613796), metal-containing carbon blacks (known from WO 98/42778), arc black and carbon blacks that are secondary products of chemical production processes can be used as starting carbon blacks. The carbon black can be activated by preliminary reactions, by oxidation for example. Coloured carbon blacks can be used. Other carbon blacks can be: conductive carbon black, carbon black for UV stabilisation, carbon black as a filler in systems other than rubber, for example in bitumen, plastics, carbon black as a reducing agent, in metallurgy.

In particular, said particle composition comprises 20 to 80% by weight of pigment and 80 to 20% by weight of resin and optionally 0.01 to 10% by weight of further excipients and/or adjuvants such as mineral reinforcing fillers and/or dispersants.

In particular, in the case of inorganic pigments, the composition preferably consists of 50 to 70% by weight of pigment, 30 to 50% of resin and 0.1 to 10% of dispersants.

In the case of organic pigments, it preferably consists of 10 to 50% by weight of pigment, preferably 20 to 40% of pigment, 45 to 75% by weight of resin, 1 to 20% by weight of mineral reinforcing fillers and 0.1 to 10% by weight of dispersants, even more preferably 20 to 35% by weight of pigment, 50 to 70% by weight of resin, 5 to 15% by weight of inert pigments and 1 to 7% by weight of dispersants.

As described in the international patent application referred to above, PCT/IT2005/000433, and in the international patent application PCT/IT2006/00588, said particle composition may optionally contain further excipients and/or adjuvants such as, for example, mineral reinforcing fillers and/or dispersants.

Said mineral reinforcing fillers are preferably chosen from carbonates, sulphates, silicates and natural and/or pyrogenic silicas.

The following are more preferably used: natural or precipitated barium sulphate, natural or coated calcium carbonate, talc, chlorites, micas, montmorillonites, natural bentonites and/or bentonite additives, natural silica oxides and their combinations and/or pyrogenic silicas such as, for example, celites, diatomaceous earth or Aerosil®.

The dispersants are preferably selected from sorbitan esters (Atmer®), epoxidised soya oils; acrylic polymers with a molecular weight between 1,000 and 20,000 Da, such as, for example, Disperbyk® 163, 181, 190, 9075 or Efka 4330, 7744 etc., metallic derivatives of sulphonic acid, Ircogel® 906, alcohol and/or amine derivatives of ethoxylated phosphoric acid (Nuosperse® FA 196). Preferably ethoxylated sorbitan ester is used, which is marketed by Uniqema as Atmer 116™.

The resins which may be used in phase a), point ii) of the method according to the invention are preferably selected from alkyd resins such as, for example, Alkydal (Bayer), acrylic resins such as, for example, Macrynal, Neocryl, Joncryl, Larodur or Maprenal, cellulose polyester resins such as, for example, nitrocellulose (Sipe S:N:P:E. WOLF), cellulose acetobutyrate (Kodak) vinyl resins such as, for example, Inylite (Union Carbide), urea or melamine resins such as, for example, Plastopal, Cibamin, Cymel U-resin (Cynamid), epoxy or hydrocarbon resins such as, for example, Necires, silicone resins such as, for example, Silicophen (Tego) or Rhodorsil (Rhone Poulenc), chlorinated rubber resins such as, for example, Pergut or Alloprene and/or a mixture thereof.

The polyester resin according to the invention is preferably chosen from pure polyesters, urethane polyesters and/or a mixture thereof.

According to the present invention, the term “water” means water characterised by a low content of dissolved mineral salts and a degree of total hardness, French degrees between 5-50, preferably between 10-20.

According to an embodiment of the invention semi, mono or bi-distilled demineralised water is used (with conductivity of less than 5 micro-Siemens. Cm−1).

The organic solvents in phase a), point iii) of the present invention are preferably partially or totally water-soluble polar organic solvents. Said solvents are more preferably selected from alcohols, esters, ketones, ethers, amines, hydrocarbons and/or mixtures thereof.

The hydrocarbons in the present invention are preferably aromatic and/or aliphatic hydrocarbons. For the purposes of the present invention alcohols are used having from 1 to 8 carbon atoms and preferably ethyl, diacetone, propyl, iso-propyl, butyl, iso-butyl, tert.-butyl, hexyl, ethylhexyl, benzyl alcohols and/or mixtures thereof.

The amines according to the invention are preferably tertiary amines and more preferably tertiary amines having from 1 to 8 carbon atoms.

Said amines are preferably selected from ammonia, triethyl amine, dimethylethanol amine, amino methyl propanol, dimethyl amino propanol amines and/or mixtures thereof.

“Ammonia” in the invention means an aqueous solution of ammonia 20 to 40% by weight.

Choice of the amines is guided by the fact that, after application of the finished product to the manufactured item, these groups evaporate from the film almost at the same time as the water and avoid filming problems (flocculation, appearance, flow, drying, lustre, odour and strengths). Said amines are also useful according to the present invention for neutralisation/solubilisation of the acid resins.

The ketones according to the invention are preferably ketones having from 1 to 8 carbon atoms, more preferably selected from methyl ketone, methyl isobutyl ketone, methyl amyl ketone, diisobutyl ketone, isophorone and/or mixtures thereof.

The esters according to the present invention are preferably esters having from 1 to 8 carbon atoms, more preferably selected from methoxy propyl acetate, n-butyl acetate, ethyl acetate, isobutyl acetate, butyl glycol acetate, butyl diglycol acetate, glycol butyl esters, 2,2,4-trimethyl-1,3-pentanediol monoisobutyrate and/or mixtures thereof.

The ethers in the present invention are ethers preferably having from 1 to 8 carbon atoms, more preferably selected from butyl glycol, butyl diglycol, methoxy propyl glycol, ethoxy propyl glycol ethers and/or mixtures thereof.

The water-solvent ratio according to the invention is between approximately 5.0-0.1 parts by weight, preferably between approximately 4.5-0.3.

The ratio between the particle composition and at least one organic solvent, water and/or mixtures thereof in the pre-mixing phase a) is respectively approximately 0.1-5 parts by weight of said particle composition to said 1 part by weight of at least one organic solvent, water and/or mixtures thereof, preferably approximately 0-4 parts by weight to 1 part by weight.

The particle sizes of said composition are between approximately 200 and 2500 microns, preferably between 1000 and 1900 microns.

According to the method according to the present invention the pre-mixing phase (a) occurs with agitation at a speed between 90 m/′ and 770 m/′, preferably between 260 m/′ and 430 m/′; for a time interval between approximately 15 and 80 minutes, preferably between approximately 25 and 50 minutes and at a temperature between 30 and 70° C., preferably between approximately 35 and 65° C.

The resins which may be used in phase b), point iv) of the method according to the present invention are preferably selected from alkyd, acrylic, polyester, cellulose, vinyl, urea, melamine, epoxy, epoxypolyamine, urethane, silicone, hydrocarbon resins, colophony resin and/or its esters, chlorinated rubber and/or a mixture thereof.

The reinforcing fillers and/or dispersants referred to in point b), v) are the same as those previously listed for point a), i).

The additives according to the invention in phase b) point v) are preferably selected from surface additives, rheological additives, plasticising additives, catalysing additives and/or mixtures thereof.

The surface additives act by modifying the surface tension of the applied film, giving characteristics of slipperiness, scratch-resistance, levelling, opacity and lustre. This category includes, for example, oils, silicone polymers, acrylate polymers (acronal), fluorinated polymers, natural waxes, synthetic waxes, synthetic coated waxes and/or a mixture thereof.

Said synthetic coated waxes are preferably coated with fluorinated compounds such as polytetrafluoroethylene (PTFE).

The rheological additives act within the preparation, improving the stability of the can during storage and may, for example, be polymers with a molecular weight between 1,000 and 20,000 Da (Byk, Disperbyk, Antiterra available from Byk Chemie, Efka or Ciba), organic and/or metallic derivatives of sulphonic acid (ircogel), paratoluene sulphonic acid, naphthenic acid, lauric (dibutyl tin dilaurate (DBTL)) acid, alcohol or amine derivatives of ethoxylated phosphoric acid (Nuosperse).

The plasticisers are preferably selected from adipates, citrates, sebacates, epoxidised soya, phthalates and/or mixtures thereof.

Said at least one organic solvent of the invention in phase b), point vi) is preferably selected from the same group as previously described for phase a), point iii).

The ratio between at least one organic solvent, water and/or a mixture thereof in the mixing phase b), point vi) and the particle composition is respectively approximately 0.1-5 parts by weight of said particle composition to 1 part by weight of said at least one organic solvent, water and/or a mixture thereof, preferably approximately 0-4 parts by weight to 1 part by weight.

Said mixing phase (b) of the invention occurs for a time interval between approximately 1 and 40 minutes, preferably between approximately 5 and 30 minutes and at a temperature between 1 and 30° C., preferably between approximately 18 and 25° C.

Said phase b) occurs by simple agitation without the need for special agitation.

The advantage of the method according to the present invention is that it eliminates the grinding phase (mills) therefore rendering manufacture of the final paint and/or ink simpler and quicker and results in the desired colour.

Elimination of the grinding phase also ensures elimination of any type of environmental pollution and pollution of the machinery due to the formation of volatile dusts during the pigment grinding process.

The mixing in the invention may advantageously be carried out either by the manufacturer of the basic paste or directly by the distributor of the final paint and/or ink (tinting in-can).

Up to now the colouring pastes have been added to neutral bases in concentrated liquid form having previously been prepared by grinding coloured pigment.

The method according to the present invention should therefore be considered to be a technological development leading to the development of tintometric systems with dispersion of colouring pigments in the form of dusts, flakes and/or granules directly into the neutral bases.

For the purposes of the invention therefore automatic metering systems, suitably modified for metering granules and/or dusts, are used.

The invention further relates to the obtaining of paint and/or ink by the dispersion method described above; the invention also relates to the use of such a paint in the automotive (including car refinishing and OEM, i.e. original equipment manufacturing), refinish, industrial coatings, powder coatings or architectural coatings industry and to the use such an ink the packaging, printing, inkjet printing or press industry.

The invention further relates to a manufactured item painted/treated with said paint and/or ink.

The examples below are valid purely for non-limiting description of the invention; the granule compositions mentioned in the examples have been obtained according to the process disclosed in PCT/IT2005/000433 (published as WO2006082603), herein incorporated by reference.

Unless stated otherwise the parts should be understood to be by weight.

### Example 1

### Quick-Drying Liquid Black Paint

a. Composition of the Black Granules:

| | |
|---|---|
| Carbon black (special black IV, manufactured by Degussa | 40.0 parts |
| Gmbh) | |
| Disperbyk (dispersant, manufactured by Byk-Chemie) | 3.0 parts |
| UA resin (aldehyde resin, manufactured by Degussa Gmbh) | 57.0 parts |

b. Paint Preparation Method:

In an appropriate item of equipment, Cowless type, 1.5 parts of methoxy propyl acetate (MPA) and 1.5 parts of n-butyl acetate (ester solvents) are weighed and agitated with an impeller at approximately 300 rpm.

5 parts of the black granules referred to in point a), with a particle size of 1000 to 1900 microns, are then introduced, slowly and under agitation to prevent it being deposited on the bottom. The speed of the rotating disc is increased to approximately 2000 rpm (peripheral speed 345 metres per minute). This condition is maintained for approximately 25 minutes until a homogeneous dispersion is achieved.

The temperature is raised to approximately 40° C.; the degree of solution of the granules is checked using a grindometer and when they are dissolved, without the presence of agglomerates, the speed is reduced. The following constituents: 70 parts of Alkydal F 48 (alkyd resin), 10 parts of S100 (aromatic hydrocarbon solvent), 11 parts of xylene (aromatic hydrocarbon solvent), 0.1 parts of silicone oil 325/OL17 (surface additive), 0.6 parts of a mixture comprising naphthenates and/or octoates of Ca, Zr, Zn and Co (additive-VX71) and 0.3 parts of methyl ethyl ketoxime (additive) are trickled in slowly and the formation is completed.

The temperature is reduced to approximately 20-25° C. and mixing is continued for approximately 10-20 minutes until the process is concluded.

### Example 2

### Bioconstituent Red Liquid Paint

a. Composition of the Red Granules:

| | |
|---|---|
| Irgazin red 2030 (organic red, manufactured by Ciba) | 40.0 parts |
| Barium sulphate (reinforcing filler) | 10.0 parts |
| Atmer (dispersant, manufactured by Uniqema) | 2.0 parts |
| UA resin (aldehyde resin, manufactured by Degussa Gmbh) | 48.0 parts |

b. Paint Preparation Method

In an appropriate item of equipment, Cowless type, 1.5 parts of methoxy propyl acetate (MPA) and 4.0 parts of n-butyl acetate (ester solvents) are weighed and agitated with an impeller at approximately 300 rpm.

15 parts of the red granules referred to in point a) are then introduced slowly and under agitation to prevent it being deposited on the bottom. The speed of the rotating disc is increased to approximately 2000 rpm (peripheral speed 345 metres per minute). This condition is maintained for approximately 25 minutes until a homogeneous dispersion is achieved.

The temperature is raised to approximately 40° C.; the degree of solution of the granules is checked using a grindometer and when they are dissolved, without the presence of agglomerates, the speed is reduced. The following constituents: 70 parts of Macrynal 510n/516 (acrylic resin), 4.09 parts of methoxy propyl acetate (MPA), 2.0 parts of butyl diglycol acetate (ester solvent), 0.01 parts of silicone (additive), 0.02 parts of dibutyl tin dilaurate (additive) are trickled in slowly and the formulation is completed.

The temperature is reduced to approximately 20-25° C. and mixing is continued for approximately 10-20 minutes until the process is concluded.

### Example 3

### White Liquid Stove Paint

a. Composition of the White Granules:

| | |
|---|---|
| Tioxide (titanium dioxide, mannufactured by Huntsman) | 75.0 parts |
| UA resin (aldehyde resin, manufactured by Degussa Gmbh) | 25.0 parts |

b. Paint Preparation Method:

In an appropriate item of equipment, Cowless type, 5.0 parts of methoxy propyl acetate (MPA) and 5.0 parts of n-butyl acetate (ester solvents) are weighed and agitated with an impeller at approximately 300 rpm.

40 parts of the white granules referred to in point a) are then introduced slowly and under agitation to prevent it being deposited on the bottom. The speed of the rotating disc is increased to approximately 2000 rpm (peripheral speed 345 metres per minute). This condition is maintained for approximately 25 minutes until a homogeneous dispersion is achieved.

The temperature is raised to approximately 40° C.; the degree of solution of the granules is checked using a grindometer and when they are dissolved, without the presence of agglomerates, the speed is reduced. The following constituents: 35 parts of Dynapol LH (polyester resin), 5 parts of Cymel 325/303 (melamine resin), 4.0 parts of 5150 (aromatic hydrocarbon solvent), 0.89 parts of butyl diglycol (ester solvent), 0.01 of silicone (surface additive), 0.1 g of Cycat 4040 (catalysing additive), 3.0 parts of Syloid ED 30 (additive) and 2.0 parts of dibasic ester (solvent) are trickled in slowly and the formulation is completed.

The temperature is reduced to approximately 20-25° C. and mixing is continued for approximately 10-20 minutes until the process is concluded.

### Example 4

### Quick-Drying Liquid Black Water Paint

a. Composition of the Black Granules:

| | |
|---|---|
| Carbon black (FW171, manufactured by Evonik Gmbh) | 25.0 parts |
| LA-D 1275 (dispersant, manufactured by Evonik Gmbh) | 3.9 parts |
| Degalan VP1035 F (acrilic resin, manufactured by Evonik | 71.1 parts |
| Gmbh) | |

b. Paint Waterborn Preparation Method:

In an appropriate item of equipment, Cowless type, 64.4 parts of diester water, 2.6 parts of n-n dimethylethanolamine (DMEA), 1.0 parts of defoamer (e.c. Byk 024) are weighed and agitated with an impeller at approximately 500 rpm (1 m/s).

32.0 parts of the black granules referred to in point a), are then introduced, slowly and under agitation to prevent it being deposited on the bottom. Live the granules there for 5 minutes at 500 rpm. The speed of the rotating disc is increased to approximately 1000 rpm (peripheral speed 2 meters per seconds) for other 5 minutes, than increase the speed at 3000 rpm (6 meters per second) for 10 minutes, after that increase the speed at 4000 rpm. This condition is maintained for approximately 35 minutes until a homogeneous dispersion is achieved.

The temperature is raised to approximately 40° C.; the degree of solution of the granules is checked using a grindometer and when they are dissolved, without the presence of agglomerates, the speed is reduced. The temperature is reduced to approximately 20-25° C. and mixing is continued for approximately 10-20 minutes until the process is concluded.

Fineness of grind achieved: <10 micron

### Example 5

### Quick-Drying Liquid Red Water Paint

a. Composition of the Red Granules:

| | |
|---|---|
| Sicotrans Rot L2817 (Transparent Ironoxide, manufactured | 40.0 parts |
| by Basf AG) | |
| Barium sulphate (reinforcing filler) | 10.0 parts |
| Dispers 655 (dispersant, manufactured by Evonik Gmbh) | 4.5 parts |
| Degalan VP1035 F (acrilic resin, manufactured by Evonik | 65.0 parts |
| Gmbh) | |

b. Paint Preparation Method

In an appropriate item of equipment, Cowless type, 65.1 parts of dester water, 2.4 parts of n-n dimethylethanolamine (DMEA), 1.0 parts of defoamer (e.c. Byk 024) are weighed and agitated with an impeller at approximately 500 rpm (1 m/s).

31.5 parts of the Transparent Ironoxide, granules referred to in point a), are then introduced, slowly and under agitation to prevent it being deposited on the bottom. The speed of the rotating disc is increased to approximately 1000 rpm (peripheral speed 2 meters per seconds) for other 5 minutes, than increase the speed at 3000 rpm (6 meters per second) for 10 minutes, after that increase the speed at 4000 rpm. This condition is maintained for approximately 40 minutes until a homogeneous dispersion is achieved.

The temperature is raised to approximately 40° C.; the degree of solution of the granules is checked using a grindometer and when they are dissolved, without the presence of agglomerates, the speed is reduced.

The temperature is reduced to approximately 20-25° C. and mixing is continued for approximately 10-20 minutes until the process is concluded.

Fineness of grind achieved: <10 micron

### Example 6

### Quick-Drying Liquid Yellow Water Paint

a. Composition of the Yellow Granules:

| | |
|---|---|
| Bayferrox 915 (Ironoxide yellow, manufactured by | 55.0 parts |
| Lanxsess AG) | |
| Atmer 116 (dispersant, manufactured by Uniqema) | 2.0 parts |
| Barium sulphate (reinforcing filler) | 15.0 parts |
| Bentone 34 | 0.5 parts |
| Degalan VP1035 F (acrylic resin, manufactured by | 27.5 parts |
| Evonik Gmbh) | |

b. Paint Preparation Method:

In an appropriate item of equipment, Cowless type, 46.2 parts of dester water, 1.8 parts of n-n dimethylethanolamine (DMEA), 1.0 parts of defoamer (e.c. Byk 024) are weighed and agitated with an impeller at approximately 500 rpm (1 m/s).

51 parts of the yellow granules referred to in point a), are then introduced, slowly and under agitation to prevent it being deposited on the bottom. The speed of the rotating disc is increased to approximately 1000 rpm (peripheral speed 2 meters per seconds) for other 5 minutes, than increase the speed at 3000 rpm (6 meters per second) for 10 minutes, after that increase the speed at 4000 rpm. This condition is maintained for approximately 30 minutes until a homogeneous dispersion is achieved.

The temperature is raised to approximately 40° C.; the degree of solution of the granules is checked using a grindometer and when they are dissolved, without the presence of agglomerates, the speed is reduced.

The temperature is reduced to approximately 20-25° C. and mixing is continued for approximately 10-20 minutes until the process is concluded.

Fineness of grind achieved: <10 micron

1. Method for preparing liquid paints and/or inks comprising the following phases:
a) pre-mixing
i) a particle composition consisting of one or more pigments coated with at least an aldehyde, ketone and/or acrylic resin and, optionally, at least one mineral reinforcing filler and/or a dispersant, said particle composition having a particle size of approximately between 200 and 3000 microns,
ii) an alkyd, acrylic, polyester, phenol, cellulose, vinyl, urea, melamine, epoxy, silicone, chlorinated rubber resin and/or a mixture thereof,
iii) at least one organic solvent, water or a mixture thereof,
with consequent obtaining of a pigment paste; and
b) mixing the pigment paste thus obtained with:
iv) at least one resin,
v) one or more additives, reinforcing fillers and/or dispersants,
vi) at least one organic solvent, water or a mixture thereof,
with consequent obtaining of the liquid paint and/or ink.

2. Method according to claim 1 wherein said resin in point b) is selected from alkyd, acrylic, polyester, phenol, cellulose, vinyl, urea, melamine, epoxy, urethane, silicone, hydrocarbon resins, colophony resin and/or its esters and/or a mixture thereof.

3. Method according to claim 1 wherein the polyester resin may be pure polyester, urethane polyester and/or a mixture thereof.

4. Method according to claim 1 wherein said organic solvent is a partially or totally water-soluble polar solvent.

5. Method according to claim 1 wherein said organic solvent is selected from alcohols, esters, ketones, ethers, amines, hydrocarbons and/or a mixture thereof.

6. Method according to claim 5 wherein said hydrocarbons are aromatic and/or aliphatic hydrocarbons.

7. Method according to claim 5 wherein said alcohols have from 1 to 8 carbon atoms.

8. Method according to claim 7 wherein said alcohols are selected from ethyl alcohol, diacetone alcohol, propyl alcohol, iso-propyl, butyl, iso-butyl, tert.-butyl, hexyl, ethylhexyl, benzyl alcohols and/or mixtures thereof.

9. Method according to claim 5 wherein said amines are tertiary amines.

10. Method according to claim 9 wherein said amines have from 1 to 8 carbon atoms.

11. Method according to claim 10 wherein said amines are selected from ammonia, triethyl amine, dimethyl ethanol amine, amino methyl propanol, dimethyl amino propanol and/or mixtures thereof.

12. Method according to claim 5 wherein said ketones have from 1 to 8 carbon atoms.

13. Method according to claim 12 wherein said ketones are selected from methyl ethyl ketone, methyl isobutyl ketone, methyl amyl ketone, diisobutyl ketone, isophorone and/or mixtures thereof.

14. Method according to claim 5 wherein said esters have from 1 to 8 carbon atoms.

15. Method according to claim 14 wherein said esters are selected from methoxy propyl acetate, n-butyl acetate, ethyl acetate, isobutyl acetate, butyl glycol acetate, butyl diglycol acetate, butyl glycol esters, 2,2,4-trimethyl-1,3-pentanediol monoisobutyrate and/or mixtures thereof.

16. Method according to claim 5 wherein said ethers have from 1 to 8 carbon atoms.

17. Method according to claim 16 wherein said ethers are selected from butyl glycol, butyl diglycol, methoxy propyl glycol, ethoxy propyl glycol ethers and/or mixtures thereof.

18. Method according to claim 1 wherein said additives are surface additives, rheological additives, plasticising additives, catalysing additives and/or mixtures thereof.

19. Method according to claim 18 wherein the surface additives are oils, silicone polymers, acrylic polymers, fluorinated polymers, natural waxes, synthetic waxes, synthetic coated waxes and/or a mixture thereof.

20. Method according to claim 19 wherein said synthetic coated waxes are coated with fluorinated compounds.

21. Method according to claim 20 wherein said fluorinated compound is polytetrafluoroethylene.

22. Method according to claim 18 wherein the rheological additives are polymers with a molecular weight between 1000 and 20,000 Da, organic and/or metallic derivatives of sulphonic acid, paratoluene sulphonic acid, naphthenic acid, lauric (dibutyl tin dilaurate (DBTL)) acid, alcohol or amine derivatives of ethoxylated phosphoric acid and/or a mixture thereof.

23. Method according to claim 18 wherein said plasticisers are selected from adipates, citrates, sebacates, epoxidised soya, phthalates and/or mixtures thereof.

24. Method according to claim 1 wherein said aldehyde, ketone and/or acrylic resins have a melting point between 70° and 130° C. and said aldehyde and/or ketone resins have an average molecular weight between 800 and 2000 Da while said acrylic resins have an average molecular weight between 800 and 5000 Da.

25. Method according to claim 24 wherein said aldehyde, ketone and/or acrylic resins have a melting point between 90° and 110° C. and said aldehyde and/or ketone resins have an average molecular weight between 900 and 14000 Da while said acrylic resins have an average molecular weight between 800 and 3000 Da.

26. Method according to claim 1 wherein said pigment is present in a quantity of 20 to 80% and said resin is present in a quantity of 20 to 80% by weight based on the particle composition.

27. Method according to claim 26 wherein said pigment is present in a quantity of 50 to 70% by weight and said resin is present in a quantity of 20 to 80% by weight.

28. Method according to claim 1 wherein said mineral reinforcing filler and/or dispersant is included in a quantity which varies from 0.01 to 10% by weight based on the particle composition.

29. Method according to claim 1 wherein said reinforcing filler is selected from natural or precipitated barium sulphate, natural or coated calcium carbonate, talc, chlorites, micas, montmorillonites, natural bentonites and/or bentonite additives, natural silica oxides and combinations thereof, pyrogenic silicas and/or mixtures thereof and said dispersant is selected from sorbitan esters, epoxidised soya oils, acrylic polymers with a molecular weight between 1000 and 20,000 Da, metallic derivatives of sulphonic acid, alcohol and/or amine derivatives of ethoxylated phosphoric acid and/or mixtures thereof.

30. Method according to claim 1 wherein the ratio between the particle composition and the water, the solvent and/or mixtures thereof in point a) is respectively 0.1-5 parts by weight of said particle composition to 1 part by weight of said at least one organic solvent, water or a mixture thereof.

31. Method according to claim 30 is which said ratio is 0.4-4 parts by weight of said particle composition to 1 part by weight of at least one organic solvent, water or a mixture thereof.

32. Method according to claim 1 wherein the ratio between the particle composition and the water, the solvent and/or a mixture thereof in point b) is respectively 0.1-5 parts by weight of said particle composition to 1 part by weight of said at least one organic solvent, water or a mixture thereof.

33. Method according to claim 32 wherein said ratio is 0.4-4 parts by weight of said particle composition to 1 part by weight of said at least one organic solvent, water or a mixture thereof.

34. (canceled)

35. Method according to claim 1 wherein the particle size of the particle composition is between approximately 1000 and 1900 microns.

36. Method according to claim 1 wherein said mixing in point a) occurs in a time interval between 15 and 80 minutes.

37. Method according to claim 1 wherein said mixing in point a) occurs in a time interval between 25 and 50 minutes.

38. Method according to claim 1 wherein said mixing in point a) occurs with continuous agitation at a speed between 90 m/′ and 770 m/′.

39. Method according to claim 1 wherein said mixing in point a) occurs with continuous agitation at a speed between 260 m/′ and 430 m/′.

40. Method according to claim 1 wherein said mixing at point a) occurs at a temperature between 30 and 70° C.

41. Method according to claim 1 wherein said mixing at point a) occurs at a temperature between between 35 and 65° C.

42. Method according to claim 1 wherein said mixing at point b) occurs in a time interval between 1 and 40 minutes.

43. Method according to claim 1 wherein said mixing at point b) occurs in a time interval between 5 and 30 minutes.

44. Method according to claim 1 wherein said mixing at point b) occurs at a temperature between 1 and 30° C.

45. Method according to claim 1 wherein said mixing at point b) occurs at a temperature between 18 and 25° C.

46. Liquid paint obtainable by the method in claim 1.

47. Ink obtainable by the method in claim 1.

48. Manufactured item painted with the paint according to claim 46.

49. Manufactured item treated with the ink according to claim 47.

50. Use of a paint according to claim 46 in the automotive, refinish, industrial coatings, powder coatings or architectural coatings industry.

51. Use of an ink according to claim 47 in the packaging, printing, inkjet printing or press industry.
